(19) United States
(12) Patent Application Publication
(10) Pub. No.: US 2009/0277815 A1
(43) Pub. Date: Nov. 12, 2009

(54) PERSONALIZED BLISTER PACK

(76) Inventor: Edwin Kohl, Perl (DE)

Correspondence Address: MARGER JOHNSON & MCCOLLOM, P.C., 210 SW MORRISON STREET, SUITE 400, PORTLAND, OR, 97204, US

(21) Appl. No.: 12/306,781

(22) PCT Filed: Jun. 28, 2007
(86) PCT No.: PCT/EP07/56469

§ 371 Date: Jan. 21, 2009

(30) Foreign Application Priority Data
Jun. 29, 2006 (EP) 06116277.2

(51) Int. Cl. A61J 1/03; B65D 83/04; A61J 7/04; G06F 19/00; B65B 17/00

(52) U.S. Cl. 206/531; 206/534; 206/539; 206/469; 700/233; 700/235; 53/410; 53/467

(57) ABSTRACT

A personalized blister pack (20) for the automated packaging of an individually defined product composition, particularly drugs, of a defined person, particularly a patient, for a defined time period comprises a plurality of receiving compartments (22), each closed by a film (25), for the products of the product composition, wherein the receiving compartments (22) are each associated with a defined usage time within the defined time period and disposed in matrix form, comprising a number of lines for usage days and columns for usage times during the day, and a memory device (50) for storing the usage data of the products of the product composition of the defined person for the defined time period, comprising a device (58) for generating a usage reminder signal as a reminder of a defined product usage time based on the stored usage data. The blister pack (20) enables a fast, safe and inexpensive supply of the needs of the person for a defined time period, such as one week, and by means of the memory device, which may comprise a reminder function, supports the planned use of the products.

### FIELD OF THE INVENTION

The invention concerns a blister pack for automated packaging of an individually defined product combination, in particular consisting of drugs for a defined person and for a defined period, e.g. a week, and an associated packaging method.

### USED PRIOR ART

From WO 2005/102862 A1, a blister pack for the weekly drug requirements of a patient, who is supposed to take the drugs in a sequence ordered by date, day of the week and time of day (morning, noon and evening and/or night), is known. The receiving compartments of the blister pack to receive the drugs are disposed in matrix form, with seven day rows each with at least three time of day compartments, which as a whole are covered by a continuous blister film. Attached to the blister pack is a cover in the form of a cardboard box, on which, specifically to each patient, the combination of the individual time of day compartments and prescription information concerning the drugs is contained.

For patients who must take several different drugs regularly, such packaging units help them, on the one hand, not to forget to take important drugs, and on the other hand, also to obtain a reliable overview of which drugs have already been taken, to avoid an overdose which may be damaging.

The weekly blister described in WO 2005/102862 A1 thus reliably supports medication of patients as required, and at the same time can be produced cheaply, and loaded individually for a large number of patients by means of a loading machine.

However, in the case of the described weekly blister pack, the printed taking instructions may be difficult to read, in particular for older patients, because of the large amount of necessary information and the printing which is limited by space. There is also the danger that the patient misses the time for using the drug.

WO 2004/002396 A1 describes a blister pack for drugs for use, in particular, in clinical tests, with a memory device for storing usage data for the drugs in the blister pack, a reminder device, and a circuit arrangement to detect, on the basis of an electrical resistance, whether a blister compartment has been opened and thus a drug has been taken.

US 2004/01721630 A1 describes a device for packaging drugs, which are packaged in circular boxes with multiple drug compartments, a circuit device, on which drug usage data to remind the patient to take them are stored, being provided.

### ABSTRACT OF THE INVENTION

It is therefore an object of the invention to develop the known personalized blister pack further, so that it provides better support for appropriate medication for the patient.

The object is achieved by a personalized blister pack for automated packaging of an individually defined product combination, particularly drugs, of a defined person, for a defined time period, comprising a plurality of receiving compartments, each closed by a foil, for the products of the product combination, said receiving compartments each being associated with a defined usage time within the defined time period and disposed in matrix form, with a number of rows for usage days and columns for usage times during the day, and a memory device for storing the usage data of the products of the product combination of the defined person for the defined period, and which includes a device for generating a usage reminder signal as a reminder of a defined product usage time based on the stored usage data.

The memory device makes it possible to store the usage data, such as the product itself, the dose, usage times etc. for the relevant person individually, so that the data can be made accessible by acoustic or visual output. In particular, the memory device makes it possible to output a usage reminder signal, which reminds the patient to take specified drugs or other preparations at a specified time. The reminder signal can be an acoustic, visual or vibration alarm signal. Signal parameters such as the volume of an acoustic signal can be adjustable, for instance.

Preferably, it is also possible to suppress the reminder signal for a specified period, in which case the suppressed signal can preferably be output displaced in time. An acknowledgment function can also be provided, either by the patient actively confirming the product usage by pressing a button or similar, or by a sensor being provided for each receiving compartment of the blister pack, and detecting the foil of the corresponding compartment being torn.

On the memory device, additional usage data of the patient, concerning further therapeutic and/or diagnostic actions such as measuring blood pressure, can be stored.

The personalized blister pack can also have a GPS unit, to detect the location of the memory device and thus of the user/patient.

According to a further embodiment, the blister pack can have an emergency call button for making an emergency call via a wireless interface, in which case, by operating the emergency call button, an access unlocking system, which, for instance, is installed on the entrance door in the user's home, can also be activated via a transponder or similar, to make access easier for emergency services or similar.

The memory element can be, for instance, an EPROM memory element, or an RFID or flash memory element. The memory element can be in the form of a memory which can be written once only, for a single use of the memory element, or a memory which can be written many times, for multiple use of the memory device. Preferably, the memory device can include an interface for receiving updated usage data for the patient, e.g. via a mobile communication network, wireless LAN, Bluetooth or similar.

In the memory device, personal identification data associated with the particular person can be stored, and it can have an output device to output the personal identification data.

The blister pack can also be provided with an identifier which is associated with the particular person, in the form of a barcode or similar, for instance.

Preferably, the memory device is attached to the blister pack removably, and has a carrying device such as a holding strap or similar. The memory device preferably has a waterproof, washable and shockproof case.

The blister pack according to the invention is suitable for packaging a wide variety of products such as drugs, vitamin preparations, food supplements and similar, in which case the memory device can store the usage data for the products which are contained in the blister pack, but also for other products.

This invention is also based on the object of proposing a method of automatically packaging an individually defined product combination, in particular consisting of drugs, for numerous persons for a defined period (e.g. a week), and simultaneously supporting the persons reliably in using the supplied products as required.

The object is achieved by a method having the steps of capturing individual product usage data of each of the numerous persons and storing them in a database, reading the usage data associated with a person for the defined period from the database, and on the basis of the read usage data, preparing and automatically packaging the appropriate product combination in a person-specific blister pack, the receiving compartments of the blister pack being disposed in matrix form, with a number of rows for usage days and columns for usage times during the day, said receiving compartments being filled with the correspondingly ordered products, storing the read usage data on a person-specific memory device, which includes a usage reminder function based on the stored usage data, and attaching the memory devices to the appropriate person-specific packaging units.

By the method according to the invention, the usage data of the products in the packaging unit, and if appropriate of other products to be used, are made available to the person or patient on the memory device, to support appropriate usage. By the reminder function, the patient is reminded to take the drugs at the correct times. The reminder can be by an acoustic signal, a visual signal or similar.

The memory device can be removably attached to the packaging unit (in particular blister pack), and be in a form for either single or repeated use. In the case of repeated use, the usage data can be updated by wireless means, e.g. via the mobile communication network, wireless LAN or a Bluetooth interface.

By the method step of checking that the personal identification data stored in the memory device agree with an identifier which is attached to the packaging unit, the correctness of the association of packaging unit and stored usage data can be verified, and the security of the method thus increased.

### BRIEF DESCRIPTION OF THE DRAWINGS

The invention is described in detail below, on the basis of embodiments and with reference to the drawings.

FIG. 1 shows a schematic perspective view of an embodiment of a weekly blister according to the invention, with memory unit.

FIG. 2 is a block diagram of an embodiment of the memory unit according to the invention.

FIG. 3 is a schematic representation, to explain an embodiment of the method according to the invention.

FIG. 4 is a flowchart to explain the method steps of the method according to the invention.

FIG. 5 is a block diagram of a further embodiment of the memory unit according to the invention.

### DETAILED DESCRIPTION OF THE INVENTION

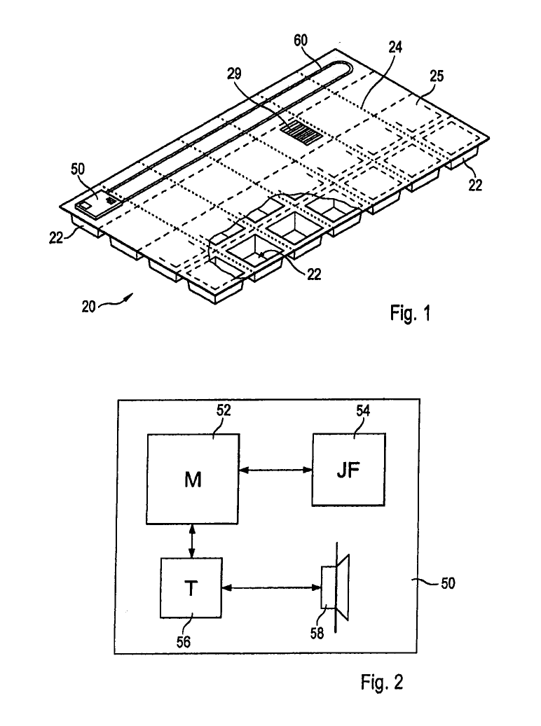

FIG. 1 shows an embodiment of a personalized blister pack 20 according to the invention. This is in the form of a so-called weekly blister, to supply a person or patient with drugs and similar products such as vitamin preparations, food supplements, etc. for the period of one week. Obviously, the invention is not restricted to a particular period. For each day of the week, on the blister pack 20, which as a whole is in matrix form, a row of (in the shown example) four receiving compartments 22, which can be separated by a perforation 24, is provided, and each contain the products to be used for “early”, “noon”, “evening” or “night”, or for “at breakfast”, “at lunch”, “at evening meal” and “before going to bed”. Depending on the field of usage, a different number of receiving compartments 22 can be provided, e.g. three receiving compartments for each meal, corresponding to before, during or after the meal.

The 28—in the embodiment shown in FIG. 1—receiving compartments 22 in total are mass-produced inexpensively from a preferably transparent thermoplastic material by deep-drawing, and each have sufficient space for multiple tablets, capsules, dragees etc. All receiving compartments 22 can be sealed by a common foil 25, e.g. a thin aluminium foil, and provided with symbols for the removal time (morning, noon, evening, night). By tearing open the thin foil, the patient can conveniently remove the products to be taken at the appropriate time of day.

Because of the perforation 24 of both the plastic board which forms the receiving compartments 22 and the foil 25, daily strips for convenient carrying can be separated from the blister pack 20.

The personalized blister pack 20 can be provided with an identifier 29 which is associated with the relevant patient, and is in the form of a bar code, for instance. However, other types of personal identifier are also possible.

To protect the blister pack, and if appropriate for printing prescription information, the blister pack, as described in WO 2005/102862, can have a hinged lid (not shown in FIG. 1). As shown in FIG. 1, the blister pack 20 is also provided with a memory device 50, in which the usage data of the products in the receiving compartments, and of other products such as food supplements, ointments etc., are stored. The memory device 50 can be in the form of a memory which can be written once only, for a single use for the period of use of the blister pack (e.g. one week), or a memory which can be written many times, and which after the week expires is returned to the pharmacy for further use, or updated by remote data transmission for the next week.

The memory device 50 can be removably attached to the blister pack 20 by adhesives, a Velcro® fastener, a holding strap or similar, so that the patient can easily remove it from the blister pack, without damaging the blister foil 25. The memory device can have a carrying device such as the shown holding strap 60, so that the patient can, for instance, hang the memory device around his or her neck, or carry it with himself or herself otherwise.

The essential elements of an embodiment of the memory device 50 according to the invention are now explained with reference to the block diagram of FIG. 2. The memory device has a memory element 52, which as mentioned above can be a memory which can be written once or one which can be written many times. For instance, an EPROM or flash memory element can be used, as can other technologies such as are known from chip cards.

Additionally, the memory device 50 has an interface unit 54, which makes it possible to write the product usage data to the memory. The interface 54 can also be designed for updating the data stored in the memory element 52, e.g. by infrared, Bluetooth, wireless LAN or a mobile communication network.

The memory device 50 also includes a timer 56 and an output unit 58, to implement a reminder function for the patient. On the basis of the patient's usage data, which are stored in the memory element 52, and which contain the period for taking the relevant drugs (morning, noon, evening, night), in relation to the relevant meals (before, during or after the meal) if appropriate, the timing device 56 supplies a signal to the output device 58, which then outputs a warning signal. In the shown example, the output device 58 is a miniaturized loudspeaker, which outputs a beep tone, or better a synthesized speech signal with precise usage instructions such as “take the red tablet before lunch” or “take the heart medicine with the evening meal”. The volume can be adjusted by means of a controller (not shown). Alternatively, of course, a visual output device which outputs the usage instructions on a small display can be used. However, the most convenient reminder function for the patient ought to be achievable using speech synthesis.

In the memory device, in addition to the usage data, personal identification data associated with the patient are stored. They can be output via the output device 58 to the user/patient for checking.

In the memory device 50, patient-related data concerning further therapeutic and/or diagnostic actions such as measuring blood pressure or similar can also be stored.

The memory device 50, like, for instance, a SIM card of a mobile telephone, can be in an inexpensive, space-saving and weight-saving form. For power supply, a power supply unit (not shown in FIG. 2) such as a small battery or a capacitor can be provided. However, the memory element 50 can also be in the form of a passive element corresponding to an RFID chip, and receive radio frequency signals via the interface unit 54, which is provided with a radio frequency aerial, and use them also for power supply.

For safe handling, the memory device is also provided with a waterproof, washable, shockproof and inexpensive case, e.g. of plastic.

Preferably, the additional option of suppressing the (possibly disturbing) reminder signal for a specified period of, for instance, 10 minutes by pressing a button or similar can be provided. Such a function is known for alarm clocks, for instance. The suppressed signal can then be output later, displaced in time, to remind the patient subsequently of the product usage which may have been missed.

Also, to check the correct drug usage according to prescription (compliance), an acknowledgment button (not shown), by which the patient acknowledges the drug usage according to prescription, can be provided. Alternatively, for this purpose, a sensor device, which for each of the receiving compartments 22 detects the tearing of the corresponding foil section, and thus deduces the drug usage according to prescription, can be provided.

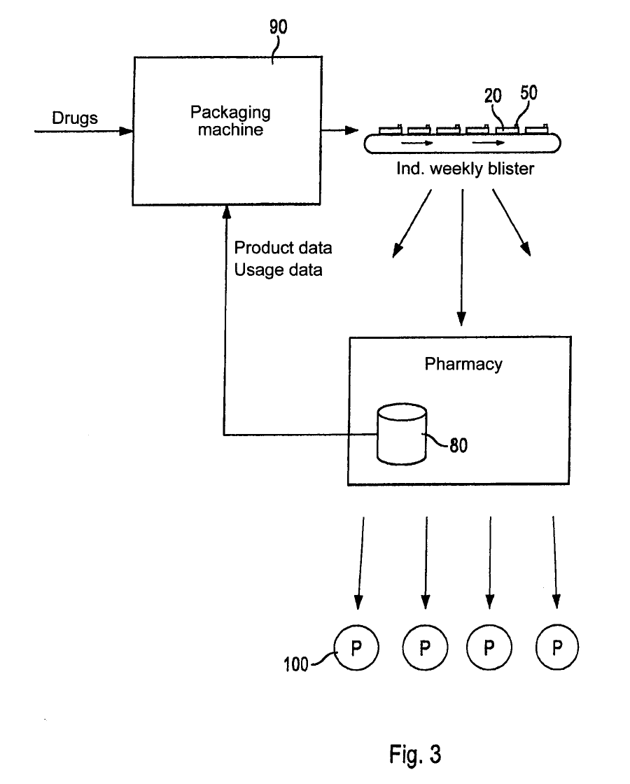

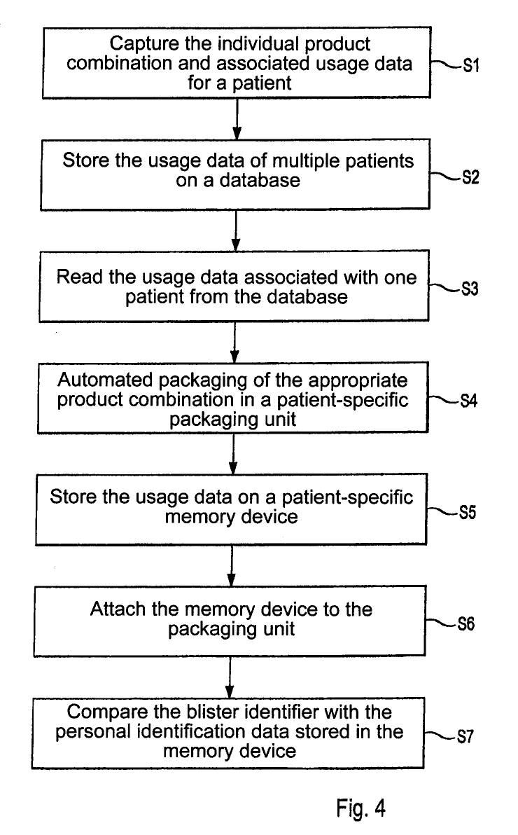

Below, with reference to FIGS. 3 and 4, an embodiment of the method according to the invention for automated packaging of an individually defined product combination for numerous patients in individual packaging units is explained.

From numerous patients 100, in a first method step S1, first the individual prescription data, i.e. the drugs and other products (vitamin preparations, food supplements, ointments etc.) which are prescribed for the patient to use are captured, preferably in the pharmacy which looks after the patient in each case, and in the following method step S2 are stored in a database 80. The database 80, as sketched in FIG. 3, can be a decentralized database which is maintained in the pharmacy, or a central database.

A packaging machine or loading machine 90, which is equipped to supply a large number (perhaps several hundred thousand) patients, is supplied with drugs in large quantities by manufacturers. For personalized, patient-specific packaging of the drugs and/or other products which are prescribed for a patient in the blister packs described above for a defined period, in method step S3 the patient's usage data are read out of the database 80, and in the subsequent method step S4 an individual blister pack 20, in which the drugs which are prescribed for this patient for the period are packaged, is assigned to each patient.

On the basis of the read usage data, in the further method step S5 these usage data are also stored on a memory device 50 which is associated with the patient, and then the memory device is attached to the packaging unit 20 in step S6. Obviously, method steps S5 and S6 can be executed in the reverse time sequence.

In the further method step S7, the personal identification data stored in the memory device are checked to agree with the identifier 29 which is attached to the packaging unit. It is thus possible to verify the correctness of the association of the packaging unit 20 with the usage data stored in the memory device 50, so that the products and usage data assigned to the patient are always supplied to him or her.

The blister packs (or weekly blisters) which are thus produced quickly, reliably and inexpensively are delivered to the appropriate pharmacies, which then make the weekly blisters, which are provided with storage elements, available to the appropriate patients. The memory device 50 can also contain usage data of products which are not supplied with the blister, e.g. ointments, medicinal teas, spa treatments or similar. According to one variant of the invention, as mentioned above, it can also be provided that the usage data on the memory device are updated, preferably by wireless means, e.g. by a special mobile communication signal or a Bluetooth or infrared interface which is provided in the pharmacy.

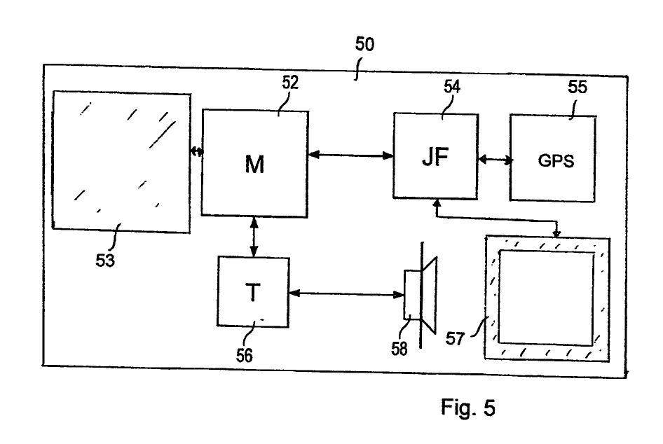

FIG. 5 shows a block diagram of the memory unit 50 according to a second embodiment of the personalized blister pack 20 according to the invention.

In addition to the elements shown in FIG. 2, the memory unit 50 of the second embodiment has a GPS unit 55, to detect the location of the memory device and thus of the user/patient. The patient's location can be passed on via the wireless interface 54 by mobile communications or similar, e.g. to a hospital or care facility, so that the targeted care for, in particular, older patients can be improved.

Additionally, the memory element 50, according to a second embodiment, has an emergency call button 57 for making an emergency call via the wireless interface 54, in which case, by operating the emergency call button 57, an access unlocking system, which, for instance, is installed on the entrance door in the user's home, can also be activated via a transponder or similar, to make access easier for emergency services.

Finally, in the case of the embodiment shown in FIG. 5, a display 53 for displaying patient data, reminder data or similar is shown.

The invention thus makes it possible to supply a large number of patients, quickly, reliably and inexpensively, with the individually prescribed product or drug combination. The convenient handling of the blister pack and the supplied memory device with reminder function support appropriate medication of the patient, so that the patient is capable of looking after himself or herself for longer, and is not directed to in-patient care.

1. Personalized blister pack for automated packaging of an individually defined product combination, particularly drugs, for a defined person, for a defined time period, having:
a plurality of receiving compartments, each closed by a foil, for the products of the product combination, said receiving compartments each being associated with a defined usage time within the defined time period and disposed in matrix form, with a number of rows for usage days and columns for usage times during the day, and
a memory device for storing the usage data of the products of the product combination of the defined person for the defined period, and which includes a device for generating a usage reminder signal as a reminder of a defined product usage time based on the stored usage data.

2. Personalized blister pack according to claim 1, wherein the product combination includes products like drugs, vitamin preparations, food supplements etc.

3. Personalized blister pack according to claim 1, wherein additional usage data of the patient, concerning products which are not in the blister pack such as drugs, vitamin preparations, food supplements etc., can be stored on the memory device.

4. Personalized blister pack according to claim 1, wherein additional usage data of the patient, concerning further therapeutic and/or diagnostic actions such as measuring blood pressure, can be stored on the memory device.

5. Personalized blister pack according to claim 1, wherein the memory device has a device for displaying the stored usage data.

6. Personalized blister pack according to claim 1, wherein the device to generate a usage reminder signal is designed to generate an acoustic signal, a visual signal or a vibration alarm signal.

7. Personalized blister pack according to claim 1, wherein the usage reminder signal can be suppressed for a specified period.

8. Personalized blister pack according to claim 7, wherein the suppressed usage reminder signal can be output displaced in time.

9. Personalized blister pack according to claim 1, having an acknowledgment button for acknowledgment of the product usage by the person.

10. Personalized blister pack according to claim 1, having a GPS unit to detect the location of the memory device.

11. Personalized blister pack according to claim 1, having an emergency call button for making an emergency call via a wireless interface.

12. Personalized blister pack according to claim 11, wherein by operating the emergency call button, an access unlocking system in the user's home is activated.

13. Personalized blister pack according to claim 1, having a sensor device to detect that the relevant receiving compartments are opened.

14. Personalized blister pack according to claim 1, wherein parameters of the usage reminder signal, in particular its volume, are adjustable.

15. Personalized blister pack according to claim 1, wherein personal identification data associated with the particular person are stored in the memory device.

16. Personalized blister pack according to claim 15, wherein the memory device has an output device to output the personal identification data.

17. Personalized blister pack according to claim 1, wherein the memory device has an EPROM memory element.

18. Personalized blister pack according to claim 1, wherein the memory device has an RFID memory element.

19. Personalized blister pack according to claim 1, wherein the memory device is in the form of a flash memory element.

20. Personalized blister pack according to claim 1, wherein the memory device is designed to store usage data including the products themselves, the form of usage, the dose, the usage period and usage times, and additional person-related and/or product-related information if required.

21. Personalized blister pack according to claim 20, wherein the memory device is designed to store detailed usage times of the products in relation to meals.

22. Personalized blister pack according to claim 1, wherein the memory device can be removed from the blister pack.

23. Personalized blister pack according to claim 1, wherein the memory device has a carrying device.

24. Personalized blister pack according to claim 1, wherein the memory device has a waterproof, washable and shockproof case.

25. Personalized blister pack according to claim 1, wherein the memory devices is designed to be used once.

26. Personalized blister pack according to claim 1, wherein the memory device has a memory element which can be written many times, for multiple use of the memory device.

27. Personalized blister pack according to claim 26, wherein the memory device has an interface for updating the usage data.

28. Personalized blister pack according to claim 1, having a hinged lid which is formed on the blister pack to cover the foil, and with labeling surfaces for printing usage information.

29. Personalized blister pack according to claim 1, having perforation sections, which make it possible to separate single rows of the blister pack, which is in the form of a matrix.

30. Personalized blister pack according to claim 1, wherein the defined period is a week, and the blister pack is in the form of a weekly blister for the needs of one week.

31. Personalized blister pack according to claim 1, which is provided with an identifier which is associated with the particular person.

32. Personalized blister pack according to claim 31, wherein the identifier is in the form of a printed identifier, e.g. a barcode.

33. Method of automatically packaging an individually defined product combination, in particular drugs, for numerous persons for a defined period, comprising:
capturing individual product usage data of each of the numerous persons and storing them in a database,
reading the usage data associated with a person for the defined period from the database, and on the basis of the read usage data,
preparing and automatically packaging the appropriate product combination in a person-specific blister pack, the receiving compartments of the blister pack being disposed in matrix form, with a number of rows for usage days and columns for usage times during the day, said receiving compartments being filled with the correspondingly ordered products,
storing the read usage data on a person-specific memory device, which memory device
includes a usage reminder function based on the stored usage data, and
attaching the memory devices to the appropriate person-specific packaging units.

34. Method according to claim 33, wherein the product combination includes products like drugs, vitamin preparations, food supplements, etc.

35. Method according to claim 33, wherein additional usage data of the person, concerning products which are not in the blister pack such as drugs, vitamin preparations, food supplements, etc., are stored on the memory device.

36. Method according to claim 33, wherein additional usage data of the patient, concerning further therapeutic and/or diagnostic actions such as measuring blood pressure, are stored on the memory device.

37. Method according to claim 33, wherein the drug packaging units and the memory devices are supplied together.

38. Method according to claim 33, wherein the usage data include the products themselves, the form of usage, the dose, the usage period and usage times, and additional person-related and/or product-related information if required.

39. Method according to claim 38, wherein the usage times include detailed usage data for the products in relation to meals.

40. Method according to claim 33, wherein all products which are required for one person, and can be transported in the blister pack, are supplied to the person by means of the packaging unit.

41. Method according to claim 33, wherein the defined period is one week.

42. Method according to claim 33, wherein the usage reminder function takes place by an acoustic, visual or vibration signal.

43. Method according to claim 33, wherein the programmable memory device is used multiple times.

44. Method according to claim 33, wherein the usage data which are stored on the memory device are updated by remote data transmission.

45. Method according to claim 44, wherein the updating takes place via the mobile communication network, wireless LAN or the Internet.

46. Method according to 33, wherein personal identification data associated with the defined person are stored in the memory device.

47. Method according to claim 33, wherein the packaging unit is provided with an identifier which is associated with the particular person.

48. Method according to claim 46, having the method step of checking that the personal identification data stored in the memory device agree with the identifier which is attached to the packaging unit.

49. Method according to claim 33, wherein the position of the memory device is detected by means of a GPS unit.

50. Method according to claim 33, wherein an emergency call can be made by means of an emergency call button and a wireless interface.

51. Method according to claim 50, wherein by operating the emergency call button, an access unlocking system in the user's home is also activated.
